(19) United States
(12) Patent Application Publication
(10) Pub. No.: US 2016/0102809 A1
(43) Pub. Date: Apr. 14, 2016

(54) CURVED SURFACE HOOK

(71) Applicant: AT SOLUTIONS. INC., Tokyo (JP)

(72) Inventor: Naoki KIKUCHI, Tokyo (JP)

(21) Appl. No.: 14/972,854

(22) Filed: Dec. 17, 2015

Related U.S. Application Data
(63) Continuation of application No. PCT/JP2014/061812, filed on Apr. 28, 2014.

(30) Foreign Application Priority Data
Jun. 21, 2013 (JP) 2013-130457

(51) Int. Cl. F16M 13/02; F16B 1/00; F16B 45/00

(52) U.S. Cl. CPC F16M 13/022; F16B 45/00; F16B 1/00; F16B 2001/0035

(57) ABSTRACT

A curved surface hook includes a body provided with a hooking portion and adsorption portions holding adsorption members adsorbable to a flat surface and a curved surface. The body and the adsorption portions are integrally formed by an elastic material, and the adsorption portions are provided so as to protrude in the radial direction about the support position of the hooking portion provided in the body. The adsorption portions are disposed substantially at the same interval about the support position of the hooking portion, and the body is provided with symmetrical thin portions formed at both sides of the line passing through the support position of the hooking portion so that the adsorption portions are curved about the line.

### TECHNICAL FIELD

The present invention relates to a curved surface hook which is attachable to a curved surface as well as a flat surface.

### BACKGROUND ART

Generally, a hook used to hook an object on a wall includes an adsorption member formed as a double-sided adhesive tape or a magnet. For example, Patent Document 1 discloses a hook structure in which front ends of four legs formed in a substantially X-shape are curved and an adsorption portion having a magnet is integrally formed with each of the front ends of the legs. The hook structure includes a hooking portion for hanging an object on a portion in which four legs intersect one another, and the four legs can be changed in shape. For this reason, the hook structure can be attached to a curved surface as well as a flat surface.

Further, Patent Document 2 discloses a hook structure in which a plurality of magnets is disposed linearly on a rear surface of a rectangular auxiliary plate. Since the auxiliary plate is formed of a bendable and soft material, the hook structure can be attached to a curved surface as well as a flat surface similarly to the configuration disclosed in Patent Document 1.

### CITATION LIST

### Patent Document

Patent Document 1: JP 2005-30581 A

Patent Document 2: JP 2011-220515 A

### DISCLOSURE OF THE INVENTION

### Problem to be Solved by the Invention

However, in the hook structure disclosed in Patent Document 1, since four legs are not disposed at the same interval, the balance of the adsorption position with respect to the load is poor when an object is hung on the hooking portion, and hence the hooking portion is directly separated. Further, since the front ends of four legs are curved toward the attachment surface so that the adsorption portions are formed at the ends, the position of the hooking portion is separated from the attachment surface. For this reason, a moment generated when an object is hung on the hook increases, and hence the hook is directly separated.

Further, in the hook structure disclosed in Patent Document 2, since the magnets are disposed linearly, a load acting on each of the magnet is not uniform, and hence the hook is easily separated. Further, since the auxiliary plate has a rectangular shape widened in the lateral direction, the attachment surface increases, and hence the attachability for a thin columnar structure is poor.

The invention is made in view of the above-described problems, and an object of the invention is to provide a compact curved surface hook which is easily attachable to a curved surface as well as a flat surface and is not easily separated.

### Means For Solving Problem

In order to solve the above-described problems, according to the invention, provided is a curved surface hook including: a body provided with a hooking portion allowing an object to be hung thereon; and an adsorption portion holding an adsorption member adsorbable to a flat surface and a curved surface, wherein the body and the adsorption portion are integrally formed by an elastic material and the adsorption portions are provided at a plurality of positions about a support position of the hooking portion provided in the body so that the adsorption portions protrude in the radial direction, wherein the adsorption portions protruding from the body are disposed substantially at the same interval about the support position of the hooking portion, and wherein the body and/or the adsorption portions are provided with symmetrical thin portions formed at both sides of the line passing through the support position of the hooking portion so that the adsorption portions are curved about the line.

In the curved surface hook with the above-described configuration, the body and the adsorption portions extending from the body in the radial direction are integrally formed by an elastic material. Since the adsorption portions are disposed substantially at the same interval about the support position of the hooking portion provided in the body, the non-uniform load for the adsorption portions decreases when an object is hung on the hooking portion, and hence the hook is not easily separated. Further, since the adsorption portions are disposed in the body so as to protrude in the radial direction, a large moment does not act on the adsorption member held by the adsorption portion when an object is hung on the hooking portion, and hence the adsorption portions are not easily separated. Further, the body and the adsorption portion are integrally formed by an elastic material, and the body and/or the adsorption portions are provided with the symmetrical thin portions formed at both sides of the line passing through the support position of the hooking portion so that the adsorption portions are curved about the line. For this reason, both sides of the line can be bent in the areas of the thin portions, and the hook can be attached to the curved surface as well as the flat surface while being deformed so as to follow a cylindrical surface or a spherical surface.

In the above-described configuration, the adsorption member held by the adsorption portion corresponds to a member such as a magnet or a double-sided adhesive tape attachable to a magnetic surface or a non-magnetic surface.

Further, in the above-described configuration, the hooking portion used for hooking an object thereon includes a configuration in which the hooking portion is fixed to the body, a configuration in which the hooking portion is supported by the body so as to be rotatable by about 90° within one plane, or a configuration in which the hooking portion is supported by the body so as to be rotatable about the axis by 360°. Alternatively, a configuration in which a base is provided in the body so as to be rotatable by 360° and the hooking portion is fixed to the base, a configuration in which the hooking portion is supported by the base so as to be rotatable by about 90° within one plane, or a configuration in which the hooking portion is supported by the base so as to be rotatable by about 360° may be employed.

Further, the thin portion is formed by the structure of the body and the adsorption portion, but may be formed only in the body, formed from the body to the adsorption portion, or formed only in the adsorption portion. Further, such a thin portion may be formed as a groove or a taper or a combination thereof as long as the thin portions are symmetrically formed at both sides of the line passing through the center position of the hooking portion (so that the thin portions are symmetrically bent). That is, the thin portions may be formed so as to be symmetrically curved in both areas (the adsorption portions located at both sides) of the line passing through the support position of the hooking portion. Further, such thin portions maybe formed at both sides of the line passing through the support position of the hooking portion. Further, the thin portions may be formed at both sides of the line orthogonal to the line. In such a configuration, the adsorption portion can be curved in a plurality of directions orthogonal to the body.

The adsorption portions may be provided at a plurality of positions of the body as long as the adsorption portions can protrude in the radial direction, and the number of the adsorption portions is not limited as long as the adsorption portions are disposed at the same interval. Further, it is desirable that the length from the support position of the hooking portion of the body to each adsorption portion be located at the same distance, but the distance from the support position to each adsorption portion may be different. In that case, it is desirable that the adsorption portions at the interval of 180° be located at the same distance.

### Effect of the Invention

According to the invention, it is possible to provide a compact curved surface hook which is easily attachable to a curved surface as well as a flat surface and is not easily separated.

### BRIEF DESCRIPTION OF DRAWINGS

FIG. 1 is a schematic diagram illustrating a basic structure of a curved surface hook according to the invention;

FIG. 2A is a bottom view illustrating a first embodiment of the curved surface hook according to the invention;

FIG. 2B is a front view illustrating a first embodiment of the curved surface hook according to the invention;

FIG. 2C is a side view illustrating a first embodiment of the curved surface hook according to the invention;

FIG. 3 is an enlarged view illustrating a hooking portion support area of the curved surface hook illustrated in FIG. 2;

FIG. 4 is a rear view of the curved surface hook illustrated in FIG. 2;

FIG. 5A is a cross-sectional view in the perpendicular direction of a body in which a hooking portion is supported;

FIG. 5B is a cross-sectional view in the horizontal direction of a body in which a hooking portion is supported;

FIG. 6A is a cross-sectional view of a portion that holds a magnet in an adsorption portion, and is a diagram illustrating an installation structure by a hook cover and a fixing tool;

FIG. 6B is a cross-sectional view of a portion that holds a magnet in an adsorption portion, and is a diagram illustrating an arrangement relation when the magnet is held by the adsorption portion;

FIG. 7 is an exploded view of the curved surface hook illustrated in FIG. 2;

FIG. 8A is a diagram illustrating an attachment example of the curved surface hook, and is a diagram illustrating a state where the curved surface hook is attached to a vertical columnar member;

FIG. 8B is a diagram illustrating an attachment example of the curved surface hook, and is a diagram illustrating a state where the curved surface hook is attached to a horizontal columnar member;

FIG. 9 is a front view illustrating a second embodiment of the curved surface hook according to the invention; and

FIG. 10 is an exploded view of the curved surface hook illustrated in FIG. 9.

### MODE(S) FOR CARRYING OUT THE INVENTION

Hereinafter, a curved surface hook according to an embodiment of the invention will be described in detail with reference to the accompanying drawings.

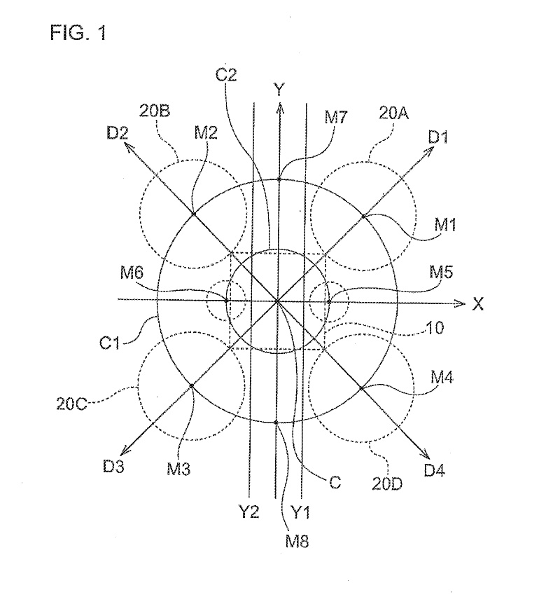

FIG. 1 is a schematic diagram illustrating a basic structure of a curved surface hook according to the invention.

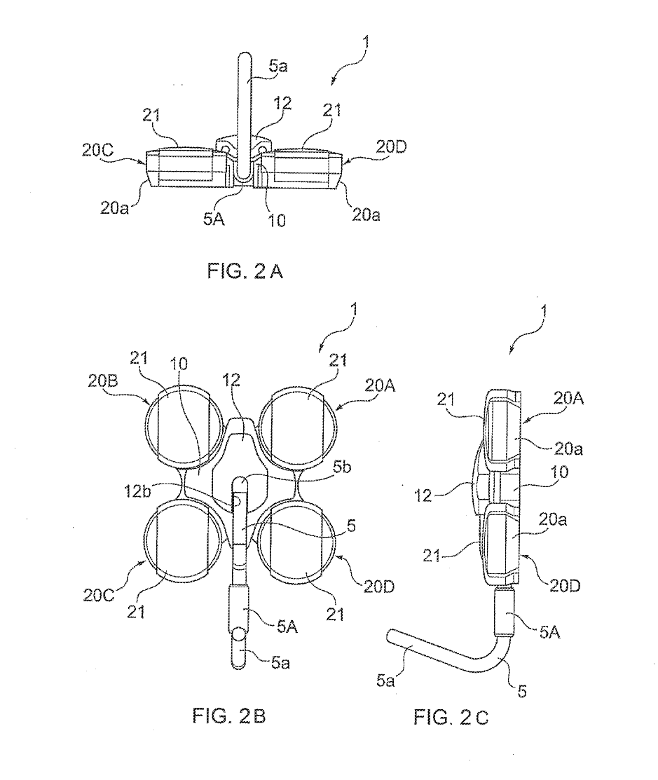

For example, as in the embodiment illustrated in FIGS. 2A to 2C, a curved surface hook 1 according to the invention includes a body 10 provided with a hooking portion (an object hooking portion) 5 for an object and adsorption portions 20A to 20D holding adsorption members adsorbable to a flat surface and a curved surface (not illustrated).

In FIG. 1, a support position C (a load application position) of the hooking portion 5 exists at the center C of the orthogonal X and Y axes, and such a hooking portion 5 is provided in a body 10 (the body 10 is indicated by a rectangular dotted line for the clear understanding). Further, the body 10 is provided with the adsorption portions 20A to 20D which are protruded in the radial direction (the radiation direction) about the support position C of the hooking portion 5.

In FIG. 1, four adsorption portions are provided, and the respective adsorption portions 20A to 20D are formed so as to protrude outward from the outer edge portion of the body 10. The adsorption portions 20A to 20D respectively hold the adsorption members (in the embodiment below, magnets), and the adsorption members respectively held by the adsorption portions 20A to 20D are adsorbable to a flat surface and a curved surface.

The adsorption portions 20A to 20D are disposed about the support position C substantially at the same interval, and in the configuration illustrated in FIG. 1, the adsorption portions are formed around the body 10 at substantially the interval of 90° in a protruding manner. Specifically, in FIG. 1, the center positions of the adsorption members respectively held by the adsorption portions 20A to 20D are indicated by the signs M1 to M4 (the adsorption center area), and the adsorption portions are disposed so that the lines D1 to D4 respectively connecting the support position C to the adsorption center areas M1 to M4 are disposed substantially at the same interval (in FIG. 1, at the interval of about) 90°.

It is desirable that the adsorption center areas M1 to M4 be disposed at the same distance from the support position C in consideration of the adsorption balance. Further, when four adsorption portions are provided, it is desirable that all adsorption center areas M1 to M4 be disposed on an arbitrary circumference C1 about the support position C as illustrated in FIG. 1. In addition, all adsorption center areas M1 to M4 may not exist at the same distance from the support position C. For example, when four adsorption portions are provided at the interval of 90°, adsorption center areas M5 and M6 may be disposed on an arbitrary circumference C2 and adsorption center areas M7 and M8 may be disposed on an arbitrary circumference C1.

The number of the adsorption portions 20A to 20D is not particularly limited, and may be appropriately changed such that two adsorption portions are provided (at the interval of about 180°), three adsorption portions are provided (at the interval of about 120°), five adsorption portions are provided (at the interval of about 72°), or six adsorption portions are provided (at the interval of about 60°). Further, there is no need to essentially dispose the adsorption portions substantially at the same interval. For example, in FIG. 1, two adsorption portions 20A and 20B may be disposed without two adsorption portions 20C and 20D. In such a configuration, the adsorption balance can be maintained in a manner such that the center areas M1 and M2 of the adsorption portions 20A and 20B are located at the same distance from the support position C.

The body 10 and the adsorption portions 20A to 20D are integrally formed by an elastic material, for example, synthetic resin such as elastomer. In this case, it is desirable to integrally form the body 10 and the adsorption portions 20A to 20D by a mold. However, the body and the adsorption portions provided separately may be integrally formed with one another.

In the body 10 and/or the adsorption portions 20A to 20D, symmetrical thin portions (where thin portion forming positions are located on the lines Y1 and Y2 so as to be symmetrical to each other about the Y axis) are formed at both sides of the line (in FIG. 1, the Y axis) passing through the center position C of the hooking portion 5. That is, when such a thin portion is formed, the adsorption portions 20A and 20B and the adsorption portions 20C and 20D are easily bent so as to be curved about the Y axis, and hence the adsorption portions easily follow the curved surface.

In this case, the thin portion is formed by the arrangement configuration of the body 10 and the adsorption portions 20A to 20D, but may be formed only in the body 10, formed from the body 10 to the adsorption portions 20A to 20D, or formed only in the adsorption portions 20A to 20D. Further, in FIG. 1, the thin portions are formed at both sides of the Y axis, but may be also formed at both sides of the X axis in addition to both sides of the Y axis. In such a configuration, since the adsorption portions are easily curved about the X axis and the Y axis, the flexibility is improved on the whole, and hence the adsorption portions easily follow the curved surface. Here, when the curved surface hook is attached to the curved surface and a heavy object is hung on the hooking portion, the displacement of the adsorption portions increases and hence the adsorption portions are easily separated. For this reason, it is desirable to employ a reinforcing means by forming a reinforcing portion between the adsorption portion and the body, forming a thick portion therebetween, or using a high-rigid material.

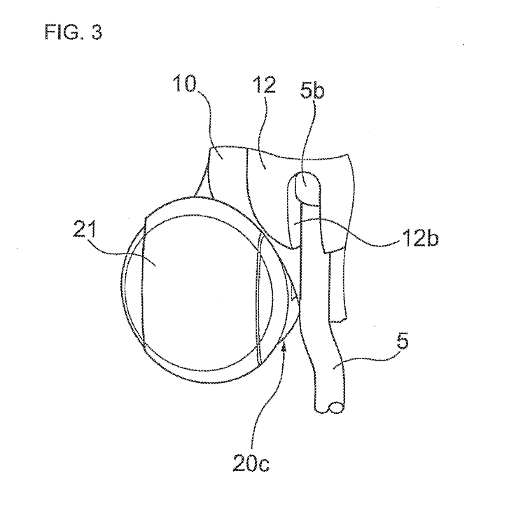

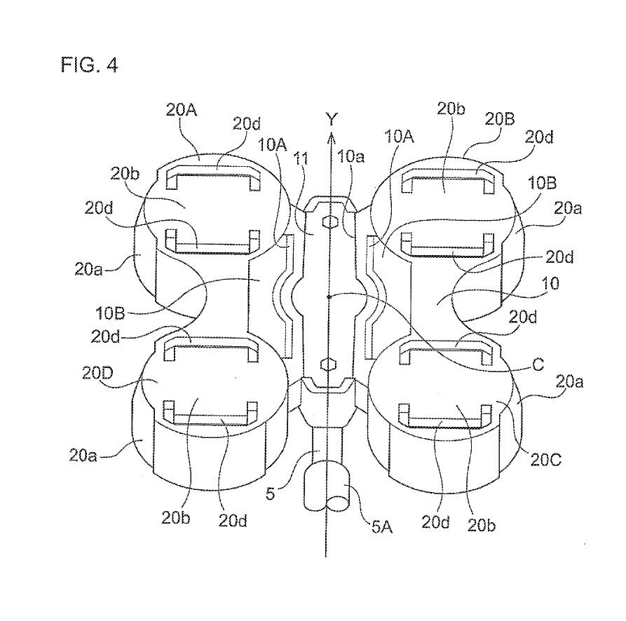

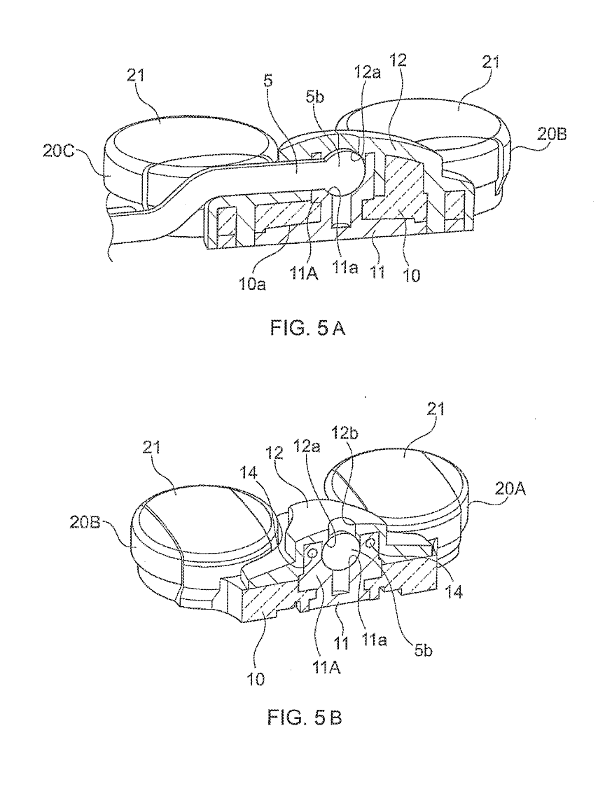

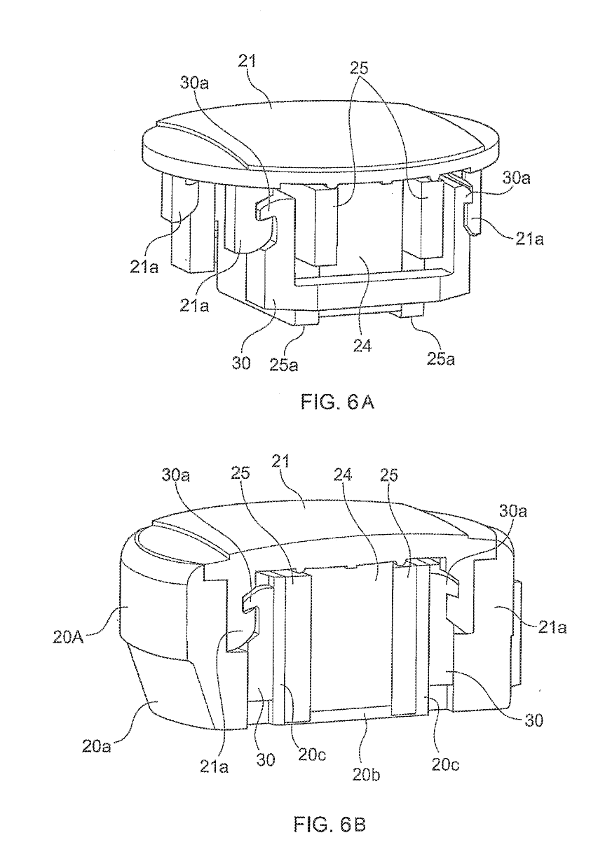

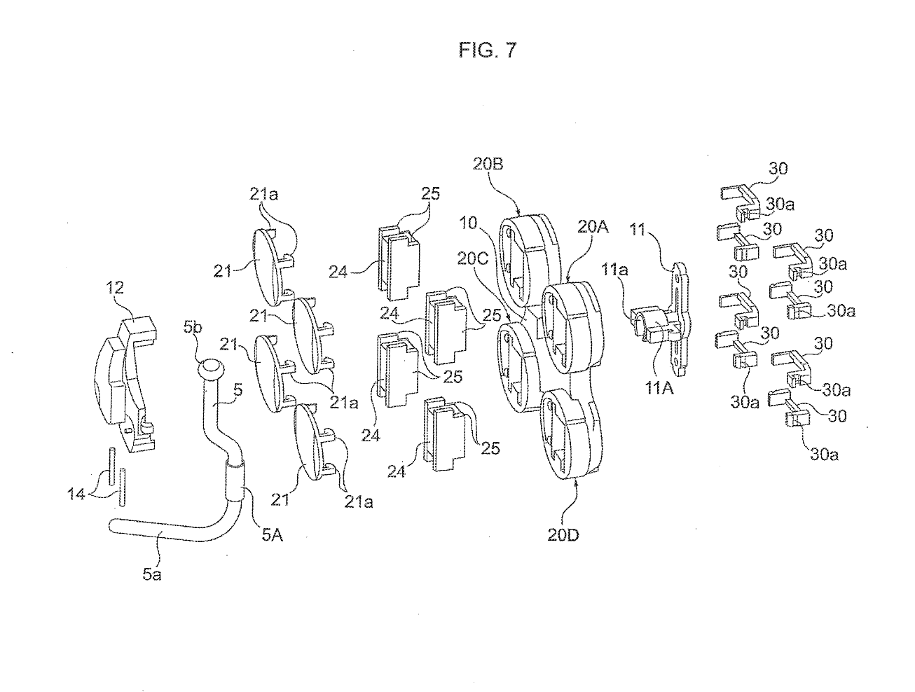

Next, the configuration of the curved surface hook according to the embodiment will be described with reference to FIGS. 2A to 7. In these drawings, FIGS. 2A to 2C are diagrams illustrating the first embodiment of the curved surface hook, where FIG. 2A is a bottom view, FIG. 2B is a front view, and FIG. 2C is a side view. FIG. 3 is an enlarged view of the hooking portion support area of the curved surface hook illustrated in FIGS. 2A to 2C. FIG. 4 is a rear view of the curved surface hook illustrated in FIGS. 2A to 2C. FIGS. 5A and 5B are cross-sectional views of the body in which the hooking portion is supported, where FIG. 5A is a cross-sectional view in the perpendicular direction and FIG. 5B is a cross-sectional view in the horizontal direction. FIGS. 6A and 6B are cross-sectional views of a portion that holds a magnet in the adsorption portion, where FIG. 6A is a diagram illustrating an installation structure using a hook cover and a fixing tool and FIG. 6B is a diagram illustrating an arrangement relation when the magnet is held by the adsorption portion. FIG. 7 is an exploded view of the curved surface hook illustrated in FIGS. 2A to 2C.

As described above, the peripheral edge portion of the body 10 is provided with four adsorption portions 20A to 20D protruding in the radial direction, and the adsorption portions 20A to 20D are formed so that the rear surfaces are flush with the rear surface of the body 10. Further, a base end portion 5b of the hooking portion 5 is supported by the center portion of the body 10. In this case, the hooking portion 5 is formed in a bar shape by metal such as stainless steel. Here, the base end portion is supported while extending from the center portion of the body 10, passing between the adsorption portions, specifically, the adsorption portion 20C and the adsorption portion 20D illustrated in FIGS. 2A to 2C, and extending downward vertically.

As illustrated in FIGS. 2A to 2C, a front end portion 5a of the hooking portion 5 is curved so that an object can be hung thereon, and the base end portion 5b is formed in a spherical shape. As illustrated in FIGS. 5A and 5B, the spherical base end portion 5b is press-inserted from the rear side of the body 10, and is held by a substantially semi-spherical recess 11a formed in a hook base 11 integrally formed with the body 10.

It is desirable to form the hook base 11 by resin harder than the body. Here, the hook base is a member that extends between the adsorption portion 20A and the adsorption portion 20B and between the adsorption portion 20C and the adsorption portion 20D at the rear side of the body 10 as illustrated in FIG. 4 and has a substantially cylindrical press-insertion portion 11A press-inserted into the body 10 as illustrated in FIGS. 5A, 5B and 7. The front end of the press-insertion portion 11A is provided with the substantially semi-spherical recess 11a, and the hooking portion 5 is held while being nipped between the hook base 11 press-inserted from the rear side of the body 10 and the hook cover 12 attached from the front side.

It is desirable to form the hook cover 12 by resin harder than the body. Here, the hook cover is a member that is attached to the hook base 11 from the front side of the body. The hook cover 12 is provided with a recess 12a which faces the substantially semi-spherical recess 11a formed in the press-insertion portion 11A of the hook base 11. When the hook cover 12 is attached to the hook base 11, the hooking portion 5 is held by the body 10 while the spherical base end portion 5b is received in the recesses 11a and 12a. In addition, the rear surface of the body 10 is provided with a recess 10a extending in the Y-axis direction (see FIG. 4). When the hook base 11 is press-inserted into the recess 10a, the hook base 11 becomes substantially flush with the rear surface of the body 10 (see FIG. 4).

An unevenness portion or a press-insertion deformation portion is provided at appropriate positions of the body 10, the hook base 11, and the hook cover 12 (the detailed structure will not be described). Accordingly, when the hook base 11 is attached to the body 10 and the hook cover 12 is attached to the hook base 11, the unevenness portions are press-inserted into each other and are elastically deformed if necessary so that the attachment state of the members is maintained. Further, when a large load is generated, the press-insertion deformation portion is deformed and the body 10 is not easily deformed. Further, as illustrated in FIGS. 5B and 7, for example, a pin 14 may be press-inserted into the hook cover 12 so that the hook cover 12 is fixed to the hook base 11. Accordingly, both members can be strongly fixed to each other so as to prevent the deformation thereof. Alternatively, a screw may be threaded from the rear surface side of the hook base 11 so as to fix the hook base 11 and the hook cover 12.

Further, in the embodiment, the hook cover 12 is provided with an opening 12b in the vertical direction (see FIG. 3), and the hooking portion 5 is supported by the body 10 so as to be rotatable by about 90° within one plane. In this case, in the embodiment, the hooking portion 5 has the spherical base end portion 5b to be received and held by the recess 11a of the hook base 11 and the recess 12a of the hook cover 12, the hooking portion 5 is supported by the body 10 so that the hooking portion is rotatable by about 90° within one plane and is rotatable about the longitudinal axis by 360°.

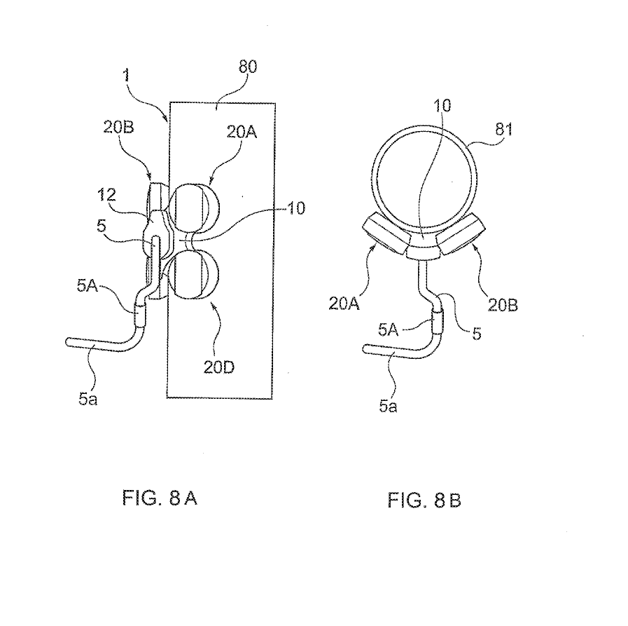

Accordingly, even when the curved surface hook is attached to a curved surface 80 extending in the vertical direction as illustrated in FIG. 8A or a curved surface 81 extending in the horizontal direction as illustrated in FIG. 8B, the hooking portion 5 is set to a position where an object can be hung perpendicularly. Further, since the hooking portion 5 is rotatable about the axis by 360°, the curved front end portion 5a can be retracted toward the curved surface 80 in the state illustrated in FIG. 8A, and hence does not cause any inconvenience in a non-use state.

Further, the hooking portion 5 may be fixed to the body 10 so as not to rotate or turn. In that case, the hooking portion 5 may be formed in a U-shape so as to correspond to the attachment state illustrated in FIG. 8A or the attachment state illustrated in FIG. 8B. Further, it is desirable to attach a tubular damper 5A (see FIG. 7) formed of rubber or the like to the hooking portion 5 so that the curved surface or the flat surface as the attachment target is not damaged. Further, the hooking portion 5 can be formed of metal or resin, and the shape or the configuration thereof can be modified into various ways. For example, the hooking portion may be formed in a carbine shape so that an object hung on the hooking portion is not simply separated therefrom. Further, the hooking portion 5 may have a configuration in which a separate rotation shaft penetrates the base end portion 5b and the rotation shaft is rotatably supported by the recess of the hook base 11 so that the hooking portion rotates by about 90° within one plane. That is, the hooking portion may not rotate about the longitudinal axis.

The body 10 is provided with symmetrical thin portions which are formed at both sides of the Y axis so that the adsorption portion can be curved about the line (the Y axis of FIGS. 1 and 4) passing through the center position C of the hooking portion 5. In this case, in the embodiment, as illustrated in FIG. 4, symmetrical thin portions are formed at both sides of the Y axis on the rear surface of the body 10. Specifically, the thin portion includes a slot 10A which extends toward the Y-axis direction and an area (a concave portion 10B) which is depressed in the rear surface of the body 10 by a step, and the slot 10A is formed in the area of the concave portion 10B.

Accordingly, both sides of the body 10 (the curved surface hook) about the Y axis can be bent in the areas of the thin portions 10A and 10B. Particularly in the area of the concave portion 10B, the flexibility is satisfactory, and the portion of the slot 10A serves as a bending point. As a result, the adsorption portions 20A and 20B and the adsorption portions 20C and 20D can be easily bent. That is, the adsorption portions 20A to 20D can be deformed so as to follow a cylindrical surface or a spherical surface while the facing adsorption portions 20A and 20B are curved and the facing adsorption portions 20C and 20D are curved. Thus, the curved surface hook 1 can be attached to the curved surface through the adsorption members (the magnets held by the yoke) held by the adsorption portions 20A to 20D as described below.

In addition, the thin portion formed in the body 10 may be formed at the front surface side and the size (the length and the width) or the shape thereof can be appropriately modified in consideration of the followingness for the curved surface. In this case, when the adsorption members at both sides can be uniformly bent, the thin portions may not be symmetrical to each other at both sides. Further, such a thin portion may have a configuration in which the adsorption portions formed at both sides of the line passing through the center position C of the hooking portion are easily curved. Here, the thin portion can be appropriately modified such that the thin portion is partially formed or is thinned by a taper shape. By the modification of the thin portion forming position and the shape of the hook cover 12, the adsorption portions 20A to 20D may have a configuration in which the facing adsorption portions 20A and 20B and the facing adsorption portions 20C and 20D are curved in a direction opposite to the curved direction illustrated in FIGS. 8A and 8B.

The thin portion may be formed from the body 10 to the adsorption portions 20A to 20D or may be formed only in the adsorption portions 20A to 20D. Further, the thin portion may be formed at both sides of the X axis orthogonal to the Y axis and passing through the center position C of the hooking portion.

Next, the configuration of the adsorption portions 20A to 20D will be described. In addition, each adsorption portion includes a magnet (an adsorption member) held by a yoke as below, and all adsorption portions have the same configuration. For this reason, FIGS. 6A and 6B representatively illustrate the configuration of the adsorption portion 20A.

The adsorption portion 20A is formed in a cylindrical shape, and an adsorption member is inserted from one (front-surface-side) opening so as to be positioned and set inside the inner space. The adsorption member includes a flat magnet 24 and a pair of flat yokes 25 sandwiching the magnet from both sides thereof. Here, a lower surface 25a of the yoke 25 becomes an adsorption portion by a magnetic circuit including the pair of yokes 25 and the magnet 24.

The opening of the adsorption portion 20A is blocked by a disk-shaped lid 21, and the adsorption member including the pair of yokes 25 and the magnet 24 is held inside the adsorption portion by the lid 21 blocking the opening and a fixing tool 30 press-inserted from the rear surface side. In this case, both sides of the fixing tool 30 are curved at right angles, and the end portion is provided with a hooking claw 30a.

The opposite side to the lid 21 attached to the adsorption portion 20A is blocked by a thin film 20b which does not affect a magnetic force. The thin film 20b can be integrally formed with the body 10 and the adsorption portions 20A to 20D. As illustrated in FIG. 4, a thin and elongated hole 20d is formed so that the fixing tool 30 is inserted thereinto. Further, since the fixing tool 30 is press-inserted at two positions of one adsorption portion, two holes 20d are formed in the thin film 20b of each of the adsorption portions 20A to 20D. Of course, the adsorption portions may be opened without the thin film 20b.

It is desirable to form a pair of protrusion walls 20c protruding perpendicularly from the thin film 20b inside the adsorption portion 20A. Such a protrusion wall 20c can be located outside the pair of yokes 25 for the positioning operation when the adsorption member including the pair of yokes 25 and the magnet 24 is inserted into the opening. Then, in this state, when the fixing tool 30 is press-inserted from the rear side and the lid 21 is attached from the front side, the adsorption member can be reliably positioned and fixed therein.

Specifically, the lid 21 is provided four hooking claws 21a protruding into the opening. As illustrated in FIGS. 6A and 6B, when the hooking claw engages with the hooking claw 30a formed in the fixing tool 30 press-inserted from the rear surface side of the adsorption portion, the adsorption member is positioned and held inside the opening. Further, as illustrated in FIG. 6B, since the protrusion wall 20c is interposed between the hooking claw 30a of the press-inserted fixing tool 30 and the yoke 25, the magnet and the yoke have a regulate movable range inside the opening. Thus, when the curved surface hook is attached to the curved surface, the yoke 25 is displaced so as to be substantially perpendicular to the curved surface, and hence the holding force can be improved.

In addition, it is desirable to employ a configuration in which the lower surface 25a of the yoke 25 as the adsorption portion is parallel to the line (the Y axis) passing through the support position C of the hooking portion 5 when the adsorption member including the magnet and the yoke is held.

When the direction of the magnet is set, a surface having a large magnetic force is disposed in the extension direction of the curved surface 80 or 81, and hence a strong adsorption force can be exhibited.

Further, it is desirable to form the cylindrical adsorption portions 20A to 20D so that an inclined surface 20a is formed on the outer peripheral surfaces thereof so as to decrease in diameter as it goes toward the attachment surface.

Since such an inclined surface 20a is formed, a finger is easily caught by an inclined portion, and hence the adsorption portions 20A to 20D are easily separated from the attachment surface. That is, when a structure in which the same withstanding load (for example; 10 Kg) is ensured by one magnet is compared with a structure in which the same withstanding load is ensured by four adsorption portions 20A to 20D as in the embodiment, the adsorption portion is easily separated from the attachment surface in the configuration of the embodiment compared with the former configuration.

Further, in the embodiment, since the magnet as the adsorption member contacts the flat surface or the curved surface through the thin film 20b, the damage of the flat surface or the curved surface can be prevented.

The curved surface hook 1 with the above-described configuration can be attached to a flat surface of, for example, a steel locker. Further, the curved surface hook 1 has a configuration in which the body 10 is integrally formed with the adsorption portions 20A to 20D extending from the body 10 in the radial direction by an elastic material. Then, the adsorption portions 20A to 20D are disposed substantially at the same interval about the support position C of the hooking portion 5 provided in the body. Accordingly, when an object is hung on the hooking portion 5, a non-uniform load with respect to the plurality of adsorption portions decreases, and hence the adsorption portions are not easily separated. Further, since the adsorption portions 20A to 20D are disposed so as to protrude in the radial direction in the body 10 (so that the adsorption portions protrude radially about the support position C), a large moment is not applied to the adsorption member held by the adsorption portions 20A to 20D when an object is hung on the hooking portion 5, and hence the adsorption portions 20A to 20D are not easily separated.

Further, since the body 10 is provided with the symmetrical thin portions 10A and 10B provided at both sides of the line (the Y axis) passing through the center position C of the hooking portion 5, both sides of the line can be bent in the areas of the thin portions. Here, the adsorption portion is deformed so as to follow a cylindrical surface or a spherical surface illustrated in FIGS. 8A and 8B so as to be attachable to the curved surface. In this case, when the curved surface hook 1 is attached to the lateral surface of the curved surface extending in the horizontal direction and a loading object is hung thereon, the curved surface hook 1 gradually moves along the curved surface by a load, and is finally fixed at the lower surface as illustrated in FIG. 8B. As described above, since the hooking portion 5 is rotatable by about 90° within the same plane, the curved surface hook is movable along the curved surface while not being separated to be dropped.

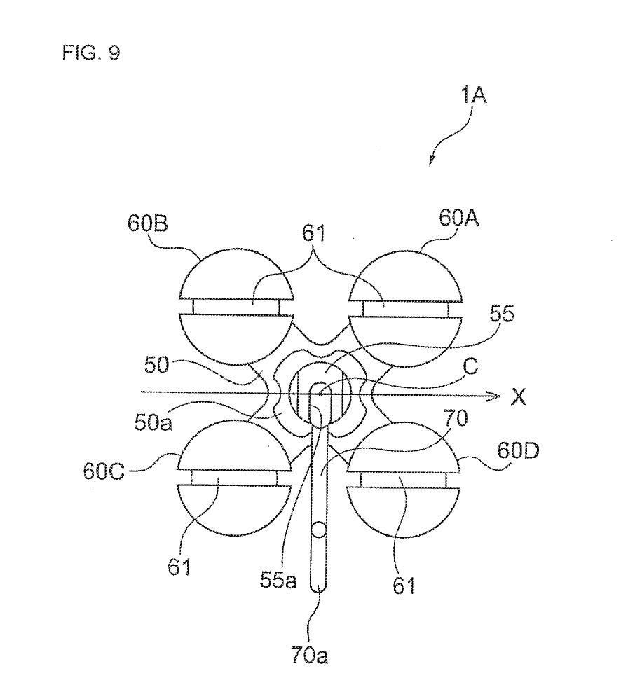

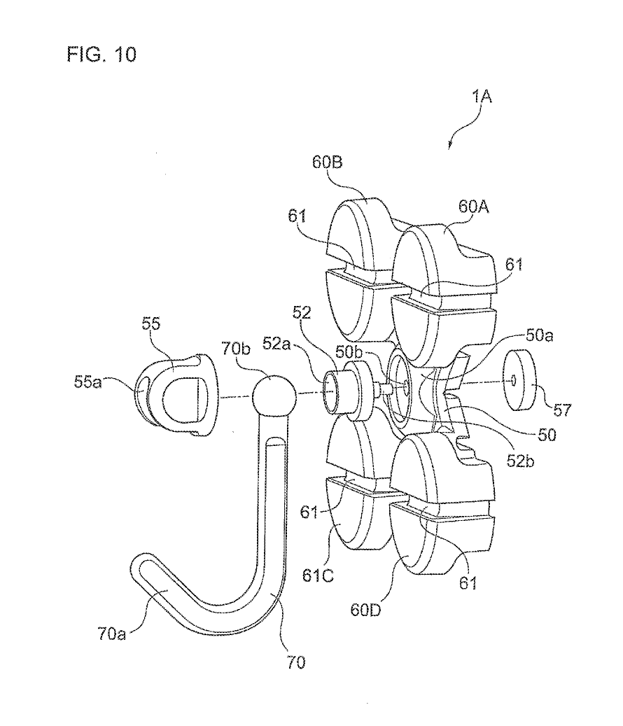

FIGS. 9 and 10 are diagrams illustrating a second embodiment of the curved surface hook according to the invention, where FIG. 9 is a front view and FIG. 10 is an exploded view of the curved surface hook illustrated in FIG. 9.

Similarly to the above-described embodiment, a curved surface hook 1A of the embodiment includes a body 50 and four adsorption portions 60A to 60D each having a substantially cylindrical shape and protruding in the radial direction about the support position C of the body 50.

The center of the body 50 is provided with a circular recess 50a, and a base 52 is attached to the portion. The center of the circular recess 50a is provided with an insertion hole 50b, and a pin 52b protruding from the base 52 is inserted into the insertion hole so that the base 52 is held by a holding member 57 from the rear side. Accordingly, the base 52 is supported by the body 50 so as to be rotatable by 360°.

The base 52 is provided with a cylindrical holding portion (a recess) 52a, and a substantially spherical base end portion 70b formed in a hooking portion 70 is provided in the portion. Further, the front end portion 70a of the hooking portion 70 is curved as illustrated in FIG. 10, and hence an object can be hung thereon. Then, a hook cover 55 having a recess receiving the base end portion is attached to the base 52, and the hook cover 55 is provided with an opening 55a so that the hooking portion 70 is rotated by 90° within the same plane.

The hooking portion 70 with such a configuration is supported so as to be rotatable by 90° within the same plane and is supported so as to be rotatable about the axis by 360°. Further, since the hooking portion 70 is held by the base 52 with the above-described configuration, the hooking portion is supported by the body 50 so as to be rotatable by 360°.

Four adsorption portions 60A to 60D are provided with symmetrical thin portions 61 formed at both sides of the line (the X axis) passing through the support position C of the hooking portion 70. Specifically, the thin portions 61 are formed as grooves provided at the front and rear surface sides of the adsorption portions 60A to 60D, and hence the adsorption portions 60A and 60D and the adsorption portions 60D and 60C are easily curved about the X axis.

When the adsorption member held by each of the adsorption portions 60A to 60D includes the magnet and the yoke similarly to the first embodiment, it is desirable to dispose the adsorption portion in the X-axis direction. For this reason, when the curved surface hook 1A is attached to a flat surface or a curved surface by a strong holding force, the hooking portion 70 may be used while being rotated by about 90° from the position illustrated in FIG. 9 by the use of the base 52. Further, as the adsorption member, a double-sided adhesive tape may be attached to each of the rear surfaces of the adsorption portions 60A to 60D.

While the embodiments of the invention have been described, the invention is not limited to the above-described embodiments, and may be modified into various forms.

For example, since the bodies 10 and 50 or the adsorption portions 20A to 20D and 60A to 60D are deformed so as to be easily separated in accordance with the weight of the object hung on the hooking portion, it is desirable to employ a reinforcing means by forming a thick portion in the body, forming a reinforcing portion in the connection portion between the adsorption portion and the body, or using a high-rigid material if necessary. Further, the shape of the body or the adsorption portion or the method of holding the adsorption member in each adsorption portion can be appropriately modified.

### EXPLANATIONS OF LETTERS OR NUMERALS

1, 1A curved surface hook

5, 70 hooking portion

10, 50 body

20A to 20D, 60A to 60D adsorption portion

20b thin film

21 lid

10A, 10B, 61 thin portion

1. A curved surface hook comprising:
a body provided with a hooking portion allowing an object to be hung thereon; and
an adsorption portion comprising an magnet adsorbable to a flat surface and a curved surface which is held by a yoke,
wherein the body and the adsorption portion are integrally formed by an elastic material and the adsorption portions are provided at a plurality of positions about a support position of the hooking portion provided in the body so that the adsorption portions protrude in the radial direction,
wherein the adsorption portions protruding from the body are disposed substantially at the same interval about the support position of the hooking portion,
wherein the body and/or the adsorption portions are provided with symmetrical thin portions formed at both sides of the line passing through the support position of the hooking portion so that the adsorption portions can be curved about the line, and
wherein an absorption section of the yoke holding the magnet is disposed so as to be parallel to the line passing through the support position of the hooking portion.

2. The curved surface hook according to claim 1,
wherein the adsorption portions are integrally formed with the body so that magnets are disposed on an arbitrary circumference about the support position of the hooking portion of the body.

3. The curved surface hook according to claim 1,
wherein the hooking portion is supported by the body so as to be rotatable by about 90° within one plane.

4. The curved surface hook according to claim 1,
wherein the hooking portion is supported by the body so as to be rotatable about the axis by 360°.

5. The curved surface hook according to claim 1,
wherein the body is provided with a base rotatable by 360° and the hooking portion is supported by the base.

6. The curved surface hook according to claim 1,
wherein the thin portion includes a groove provided in the direction of the line.

7. The curved surface hook according to claim 1,
wherein the thin portion includes a concave portion or a tapered portion formed at both sides of the line.

8. The curved surface hook according to claim 1,
wherein each adsorption portion is provided with an opening, the yoke holding the magnet is held inside the opening, and the opening is blocked by a lid.

9. The curved surface hook according to claim 8,
wherein a thin film is integrally formed with each adsorption portion at the opposite side to the lid and the adsorption portion is adsorbed to the flat surface and the curved surface through the thin film.
